(19) United States
(12) Patent Application Publication
(10) Pub. No.: US 2020/0143351 A1
(43) Pub. Date: May 7, 2020

(54) POS TERMINAL DEVICE AND POS SYSTEM

(71) Applicant: NEC Platforms, Ltd., Kawasaki-shi, Kanagawa (JP)

(72) Inventor: Takuya HIRAO, Kanagawa (JP)

(73) Assignee: NEC Platforms, Ltd., Kawasaki-shi, Kanagawa (JP)

(21) Appl. No.: 16/609,498

(22) PCT Filed: Apr. 18, 2018
(86) PCT No.: PCT/JP2018/016018

§ 371 Date: Oct. 30, 2019

(30) Foreign Application Priority Data
May 12, 2017 (JP) 2017-095939

(51) Int. Cl. G06Q 20/20; G06Q 20/10; G06F 3/0484

(52) U.S. Cl. CPC G06Q 20/201; G06Q 20/209; G06F 3/04847; G06Q 20/203; G06Q 20/108

(57) ABSTRACT

Provided is a POS device, configured to be capable of accepting payment by electronic money as well as cash, said device comprising a control unit for performing settlement by subtracting a payment amount of a payment in cash or a payment in electronic money from a merchandise cost of merchandise purchased by a customer. The control unit accepts the payment amount of the payment in cash and the payment amount of the payment in electronic money and performs settlement of the merchandise cost. The payment amount of the payment in electronic money is an arbitrary desired amount that the customer desires to pay in electronic money.

### TECHNICAL FIELD

This invention relates to a POS terminal device and a POS system including the POS terminal device.

### BACKGROUND ART

Some payment devices, for example, a POS (Point Of Sales) terminal device configured to settle the payment of a product to be purchased, support not only payment by cash but also payment by electronic money.

In Patent Document 1 (JP 2015-018482 A), there is disclosed a product sales data processing device configured to perform settlement processing by specifying electronic money.

In the payment device that supports electronic money, the electronic money is used in the following ways (1) and (2), for example.

(1) The total amount of a product price is paid by electronic money. As a specific example, when the total amount of a product to be purchased is 220 yen, the total amount of the product price of 220 yen is paid by an electronic money A with the balance of 230 yen.

(2) After payment by electronic money, when there is an outstanding balance (insufficient amount), the outstanding balance is paid by cash or other electronic money. As a specific example, when the total amount of a product to be purchased is 220 yen and the total amount of the product price of 220 yen is paid by the electronic money A with the balance of 200 yen for the total amount of the balance of 200 yen, there is an outstanding balance (insufficient amount) of 20 yen. In this case, the outstanding balance of 20 yen is paid by cash (additional money) or another electronic money B (additional electronic money) with the balance of 20 yen or more.

### PRIOR ART DOCUMENTS

### Patent Document

Patent Document 1: JP 2015-018482 A

### SUMMARY OF THE INVENTION

### Problem to be Solved by the Invention

The payment devices that support electronic money, including the one disclosed in Patent Document 1, cannot settle the payment of an amount freely desired by a customer for payment by electronic money. Meanwhile, some customers desire to strictly manage the balance of electronic money.

This invention has an object to provide a technology for solving the above-mentioned problem, and provide a POS terminal device capable of setting the amount of payment by electronic money to any amount desired by a customer.

This invention has another object to provide a POS system including the above-mentioned POS terminal device.

According to this invention, there is provided a POS terminal device, which is configured to receive payment by cash and payment by electronic money, the POS terminal device comprising a control unit configured to settle a payment by subtracting, from a product price of a product to be purchased by a customer, an amount to be paid by the cash or to be paid by the electronic money, in which the control unit is configured to settle the payment of the product price by receiving the amount to be paid by the cash and the amount to be paid by the electronic money, and, in which the amount to be paid by the electronic money is a desired amount, which is any amount desired by the customer for the payment by electronic money.

According to this invention, there is further provided a POS system, comprising the POS terminal device of any one of claims 1 to 9 and a shop server, in which the shop server includes a storage unit storing a PLU file that associates a product code with information on a product, and is configured to return, in response to transmission of a product code from the POS terminal device, information on a product corresponding to the product code, in which the POS terminal device is configured to calculate the product price based on the information on the product returned by the shop server.

### Effect of the Invention

The POS terminal device according to this invention is capable of setting the amount of payment by electronic money to any amount desired by a customer.

### BRIEF DESCRIPTION OF THE DRAWING

FIG. 1 is a diagram for illustrating a POS system according to embodiments of this invention.

FIG. 2 is a diagram for illustrating the POS system according to embodiments of this invention in which (a) is a shop server and (b) is a POS terminal device.

FIG. 3 is a flowchart for illustrating an operation of the POS terminal device in a POS system according to a first embodiment of this invention.

FIG. 4 is a flowchart for illustrating the operation of the POS terminal device in the POS system according to the first embodiment of this invention.

FIG. 5 is a diagram for illustrating a clerk operation screen to be displayed and output by the POS terminal device in the POS system according to the first embodiment of this invention.

FIG. 6 is a diagram for illustrating an example of a receipt to be printed and output by the POS terminal device in the POS system according to the first embodiment of this invention.

FIG. 7 is a flowchart for illustrating an operation of the POS terminal device in a POS system according to a second embodiment of this invention.

FIG. 8 is a flowchart for illustrating the operation of the POS terminal device in the POS system according to the second embodiment of this invention.

FIG. 9 is a flowchart for illustrating the operation of the POS terminal device in the POS system according to the second embodiment of this invention.

FIG. 10 includes diagrams for illustrating examples of the clerk operation screen to be displayed and output by the POS terminal device in the POS system according to the second embodiment of this invention, in which (a) is an example after calculation of the total amount of a product to be purchased, and (b) is an example after completion of payment.

FIG. 11 includes diagrams for illustrating examples of the receipt to be printed and output by the POS terminal device in the POS system according to the second embodiment of this invention, in which (a) is an example of a temporary receipt to be issued in the middle of payment, and (b) is an example of the receipt to be issued at the time of completion of payment.

FIG. 12 is a flowchart for illustrating an operation of the POS terminal device in a POS system according to a third embodiment of this invention.

FIG. 13 is a flowchart for illustrating the operation of the POS terminal device in the POS system according to the third embodiment of this invention.

FIG. 14 is a flowchart for illustrating the operation of the POS terminal device in the POS system according to the third embodiment of this invention.

FIG. 15 includes diagrams for illustrating examples of the clerk operation screen to be displayed and output by the POS terminal device in the POS system according to the third embodiment of this invention, in which (a) is an example after calculation of the total amount of a product to be purchased, and (b) is an example after completion of payment.

FIG. 16 includes diagrams for illustrating examples of the receipt to be printed and output by the POS terminal device in the POS system according to the third embodiment of this invention, in which (a) is an example of the temporary receipt to be issued in the middle of payment, and (b) is an example of the receipt to be issued at the time of completion of payment.

FIG. 17 is a flowchart for illustrating an operation of the POS terminal device in a POS system according to a fourth embodiment of this invention.

FIG. 18 is a flowchart for illustrating the operation of the POS terminal device in the POS system according to the fourth embodiment of this invention.

FIG. 19 is a flowchart for illustrating the operation of the POS terminal device in the POS system according to the fourth embodiment of this invention.

FIG. 20 includes diagrams for illustrating examples of the clerk operation screen to be displayed and output by the POS terminal device in the POS system according to the fourth embodiment of this invention, in which (a) is an example after calculation of the total amount of a product to be purchased, and (b) is an example after completion of payment.

FIG. 21 includes diagrams for illustrating examples of the receipt to be printed and output by the POS terminal device in the POS system according to the fourth embodiment of this invention, in which (a) is an example of the temporary receipt to be issued in the middle of payment, and (b) is an example of the receipt to be issued at the time of completion of payment.

### MODES FOR EMBODYING THE INVENTION

### First Embodiment

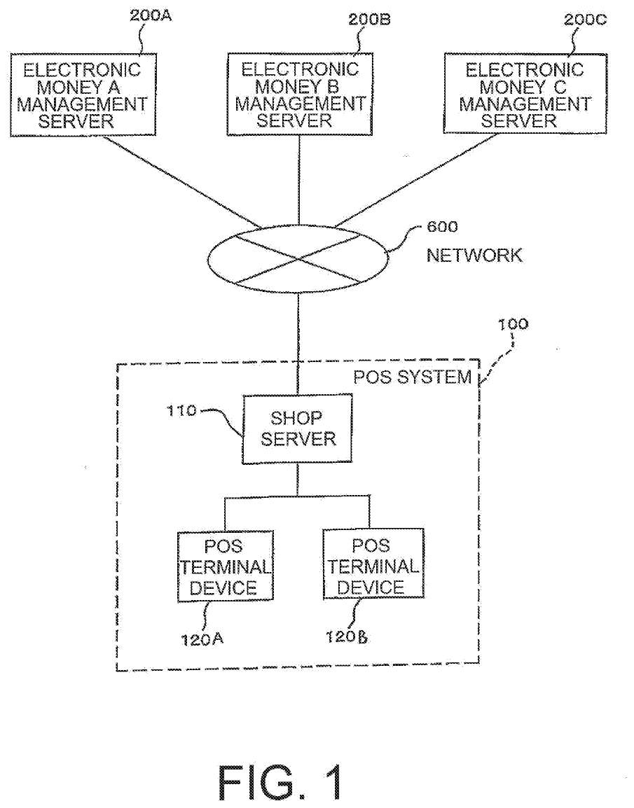

Now, a description is given of a first embodiment of this invention with reference to FIG. 1 to FIG. 6.

Referring to FIG. 1, a POS system 100 according to a first embodiment of this invention includes a shop server 110 installed in a shop and two POS terminal devices 120A (120B). The shop server 110 and the POS terminal device 120A (120B) are connected to each other so as to enable communication in a wired or wireless manner.

In this invention, there may be one POS terminal device, or may be three or more POS terminal devices. Further, one POS terminal device may also have a shop server function.

The shop server 110 of the POS system 100 can communicate to/from an electronic money A management server 200A, an electronic money B management server 200B, and an electronic money C management server 200C via a network (e.g., integrated services digital network (ISDN)) 600.

Each of the electronic money management servers manages transaction data on each of the electronic money A, the electronic money B, or the electronic money C for each identification (ID) number.

The network 600 may be other communication networks (e.g., Internet) enabling communication of data.

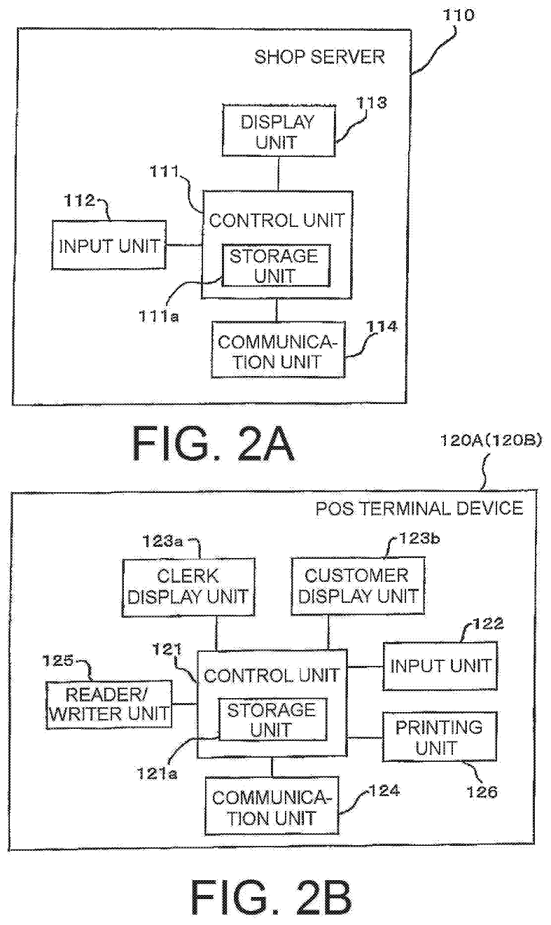

Referring to FIG. 2 (a), the shop server 110, which is constructed of a computer, includes an input unit 112 configured to receive input of data and the like, a display unit 113 configured to display a result of information processing and the like, a communication unit 114 configured to communicate to/from other apparatus, and a control unit 111, which includes a storage unit 111a storing an application program and the like, and is configured to perform overall control.

The shop server 110 stores a price look-up (PLU) file associating a product code with information (e.g., product name and price) on the product, and transmits information on a product in response to transmission of a product code from each POS terminal device, manages sales data transmitted from each POS terminal device, transmits information on electronic money transmitted from each POS terminal device to the electronic money management server, transmits information on electronic money transmitted from the electronic money management server to each POS terminal device, and performs other such processing.

Referring to FIG. 2 (b), the POS terminal device 120A (120B) is constructed of a computer, and includes an input unit 122 configured to receive input of data and the like, a clerk display unit 123a and a customer display unit 123b each configured to display a result of information processing and the like, a printing unit 126 configured to print a receipt and the like, a communication unit 124 configured to communicate to/from other apparatus, a reader/writer unit 125 configured to perform non-contact communication or contact communication to/from an electronic money medium such as an IC card or a mobile terminal device having mounted thereon an integrated circuit (IC) chip, and a control unit 121, which includes a storage unit 121a configured to store an application program and the like, and is configured to perform overall control.

Although not shown, the POS terminal device 120A (120B) includes a cash drawer that can be opened/closed. The control unit 121 controls opening/closing of the cash drawer in accordance with an operation performed by a clerk, or automatically when opening/closing is required. Cash received from the customer for payment is stored into the cash drawer by the clerk. Meanwhile, when there is a change, cash corresponding to that amount is taken from the cash drawer by the clerk, and is given to the customer as a change.

In this example, the clerk display unit 123a and the customer display unit 123b each include a display with a touch panel. Thus, at least a part of the input unit 122 includes software buttons for displaying assignment of buttons on those display units.

The reader/writer unit 125, which receives an instruction from the control unit 121, reads the balance of electronic money stored in an electronic money medium, or deducts a product price from the balance of electronic money for payment of the product price to write the balance after the deduction.

The POS terminal device 120A (120B) registers a product to be purchased by the customer, and settles the payment of the product price by cash or electronic money. Further, the POS terminal device 120A (120B) transmits/receives data on electronic money to/from the electronic money A management server 200A, the electronic money B management server 200B, and the electronic money C management server 200C via the shop server 110.

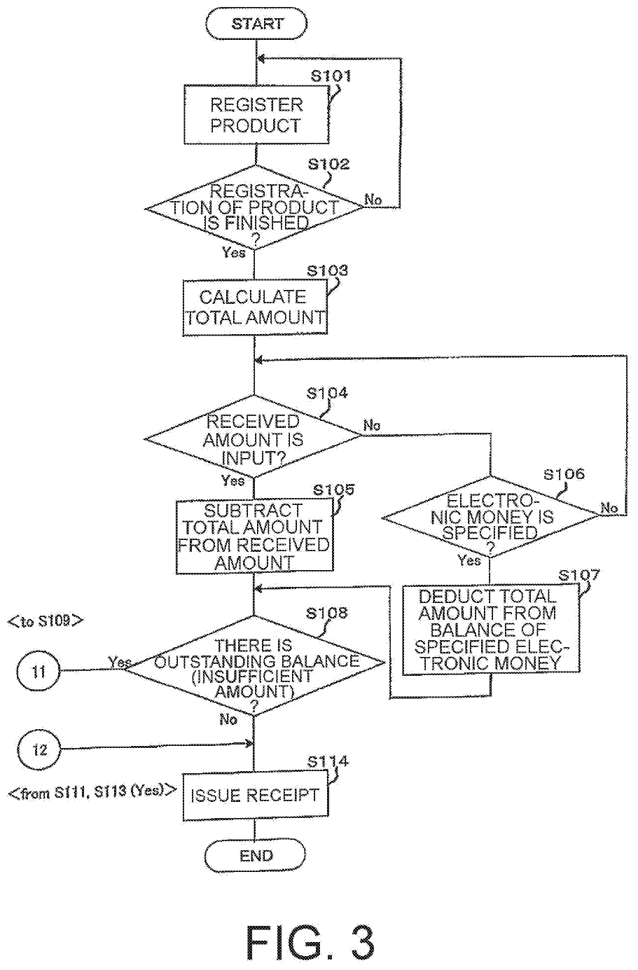

Next, referring to FIG. 3 to FIG. 6, a description is given of an operation of the POS system 100 according to the first embodiment, specifically, an operation of the POS terminal device 120A (120B) in the first embodiment.

The POS terminal device 120A (120B) in the first embodiment performs payment roughly in the following procedure.

(A) The POS terminal device 120A (120B) calculates the total amount of a product to be purchased by a customer.

(B) It waits for input of a received amount, which is an amount of cash received from the customer for payment, or specification of any one of the electronic money A, the electronic money B, and the electronic money C.

(C) It calculates an outstanding balance (insufficient amount), which is obtained by subtracting, from the total amount, a desired amount being any amount desired for payment by specified electronic money, settles the payment of the outstanding balance (insufficient amount) by cash, and then settles the payment of the outstanding balance (insufficient amount) by electronic money other than the specified electronic money.

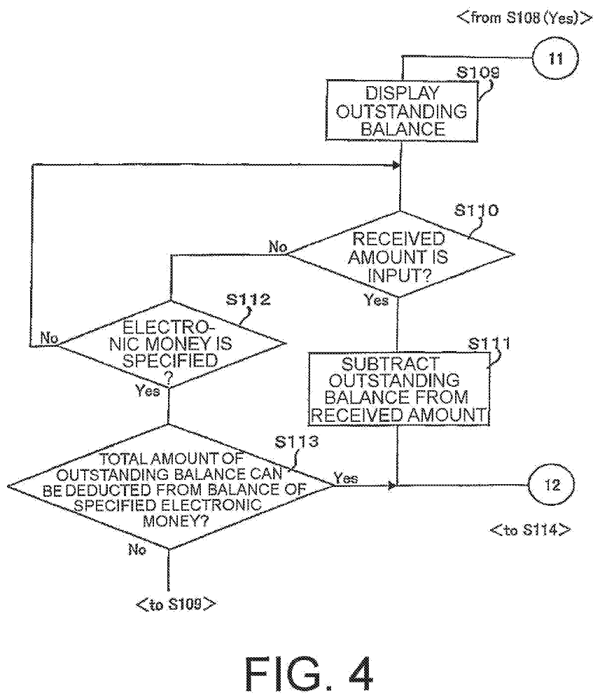

FIG. 3 and FIG. 4 are flowcharts for illustrating processing to be executed by the control unit 121 of the POS terminal device 120A (120B) in the first embodiment from registration of a product to be purchased by the customer until payment of the product price.

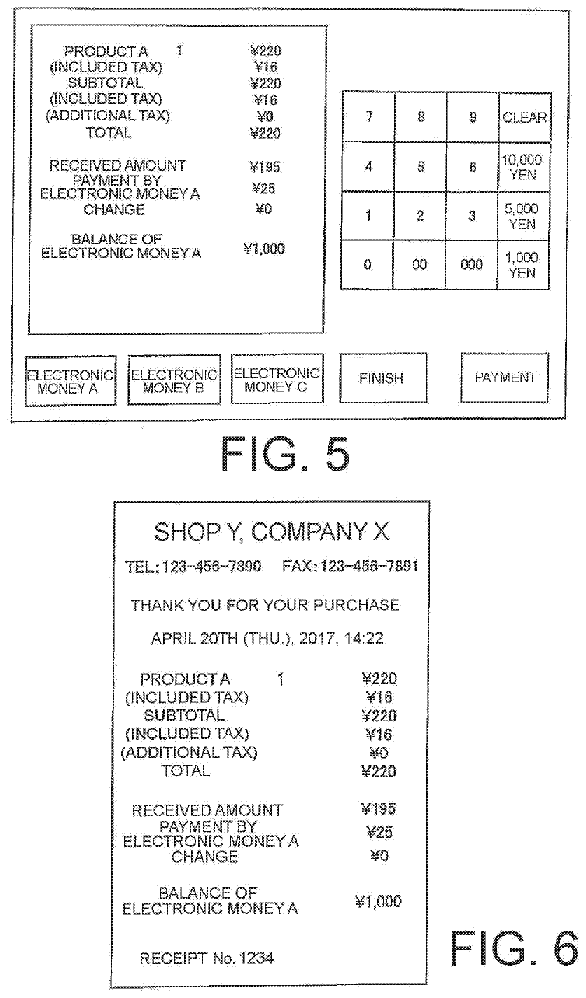

FIG. 5 is an example of a clerk operation screen to be displayed on the clerk display unit 123a (FIG. 2 (b)) at that time. FIG. 6 is an example of a receipt to be issued by the printing unit 126 (FIG. 2 (b)) at that time.

In Step S101, a product to be purchased by the customer is registered.

In Step S102, it is determined whether the registration of the product is finished. When the registration of the product is finished (“Yes” in Step S102), the processing proceeds to Step S103. On the contrary, when the registration of the product is not finished (“No” in Step S102), the processing returns to Step S101.

In Step S103, the total amount is calculated in cooperation with the shop server 110 and the total amount is displayed on the clerk display unit 123a and the customer display unit 123b (FIG. 2 (b)), and the processing proceeds to Step S104.

In Step S104, it is determined whether the clerk has received cash for payment from the customer and the clerk has input a received amount. When the received amount is input (“Yes” in Step S104), the processing proceeds to Step S105. Otherwise (“No” in Step S104), the processing proceeds to Step S106.

In Step S105, payment by cash is received. Specifically, an outstanding balance (insufficient amount) is calculated by subtracting the total amount from the received amount, and the processing proceeds to Step S108.

In Step S106, it is determined whether the customer has specified electronic money. When the customer has exhibited an intention to settle the payment by using any one of the electronic money A, the electronic money B, and the electronic money C, and has specified any one of those electronic moneys (“Yes” in Step S106), the processing proceeds to Step S107. Otherwise (“No” in Step S106), the processing returns to Step S104.

When the customer has exhibited an intention to settle the payment by using any one of the electronic money A, the electronic money B, and the electronic money C, and has specified any one of those electronic moneys, this means that the customer has verbally notified the clerk of that intention, and the clerk has pressed any one of keys of the electronic money A, the electronic money B, and the electronic money C on the clerk operation screen (refer to FIG. 5) displayed on the clerk display unit 123a (FIG. 2 (b)), or the customer has pressed any one of keys of the electronic money A, the electronic money B, and the electronic money C on a customer operation screen (not shown).

In Step S107, payment by the specified electronic money is received. Specifically, the total amount is deducted from the balance of the specified electronic money, and the processing proceeds to Step S108.

In Step S108, it is determined whether there is an outstanding balance (insufficient amount). When there is an outstanding balance (insufficient amount) (“Yes” in Step S108), the processing proceeds to Step S109. Otherwise (“No” in Step S108), the processing proceeds to Step S114.

In Step S109, the outstanding balance is displayed on the clerk display unit 123a and the customer display unit 123b, and the processing proceeds to Step S110.

In Step S110, it is determined whether the clerk has received cash for payment (additional money) from the customer and the clerk has input a received amount. When the received amount is input (“Yes” in Step S110), the processing proceeds to Step S111. Otherwise (“No” in Step S110), the processing proceeds to Step S112.

In Step S111, an outstanding balance (insufficient amount) is calculated by subtracting the outstanding balance from the received amount, and the processing proceeds to Step S114.

In Step S112, it is determined whether the customer has specified electronic money. When the customer has specified any one of the electronic moneys (“Yes” in Step S112), the processing proceeds to Step S113. Otherwise (“No” in Step S112), the processing returns to Step S110.

In Step S113, it is determined whether the total amount of the outstanding balance can be deducted from the balance of the specified electronic money. When the total amount of the outstanding balance can be deducted from the balance of the specified electronic money (“Yes” in Step S113), the processing proceeds to Step S114. On the contrary, when the total amount of the outstanding balance cannot be deducted (“No” in Step S113), the processing returns to Step S109.

Transaction data on electronic money is transmitted to the electronic money A management server 200A, the electronic money B management server 200B, or the electronic money C management server 200C corresponding to the used electronic money via the shop server 110.

In Step S114, the printing unit 126 (FIG. 2 (b)) issues a receipt (FIG. 6). At this time, when there is a change, the clerk gives the change to the customer together with the receipt.

A specific example is given in the following.

The total amount of a product to be purchased is 220 yen. Meanwhile, the customer desires to pay 25 yen, which is any desired amount, by electronic money, which is the electronic money A with the balance of 1,025 yen. The customer pays by cash 195 yen, which is an amount obtained by subtracting, from the total amount of 220 yen, 25 yen being an amount to be paid by the electronic money A, and then pays the outstanding balance by the electronic money A. The clerk operation screen to be displayed on the clerk display unit 123a (FIG. 2 (b)) at this time is illustrated in FIG. 5, and the receipt is illustrated in FIG. 6.

The POS system according to the first embodiment described above can set the amount of payment by electronic money to any amount desired by the customer.

### Second Embodiment

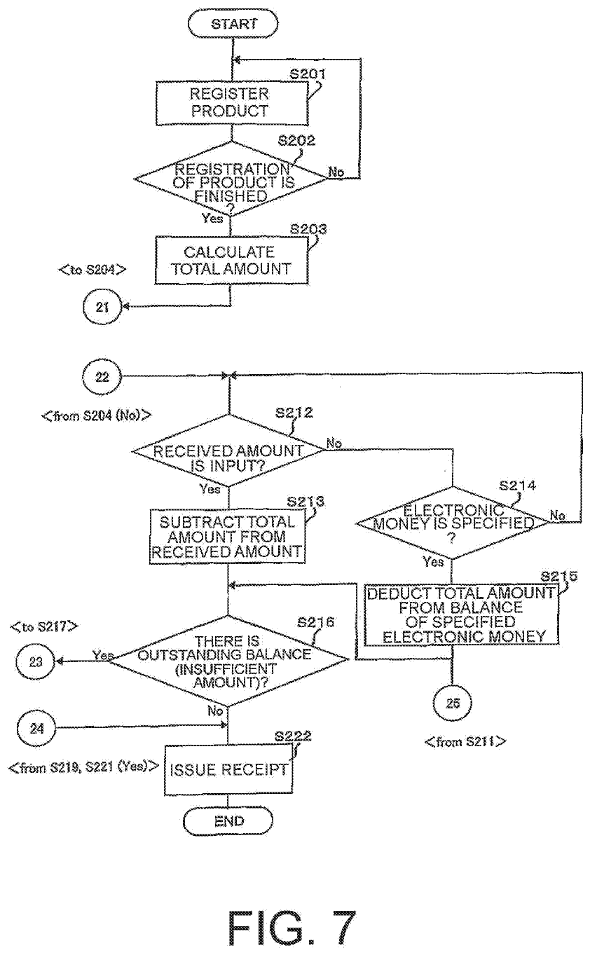

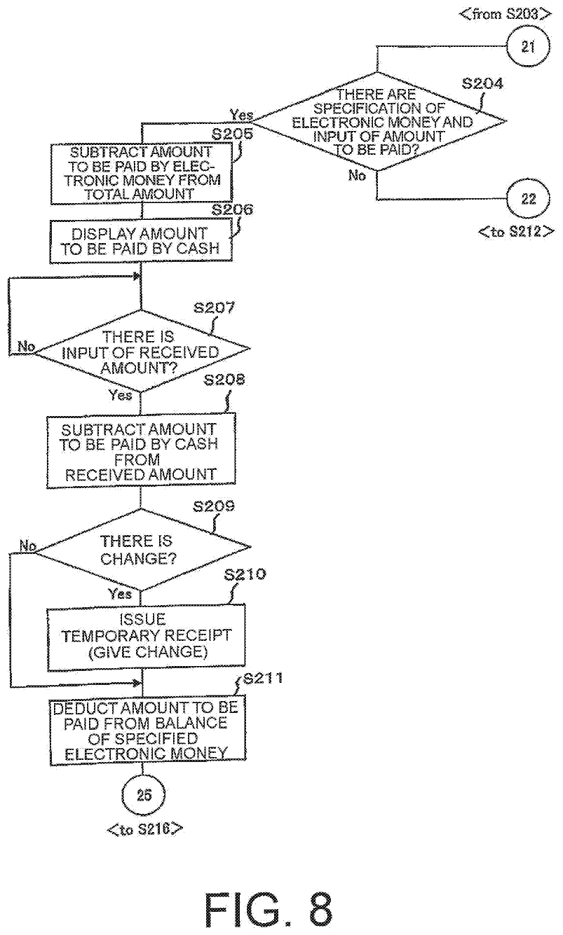

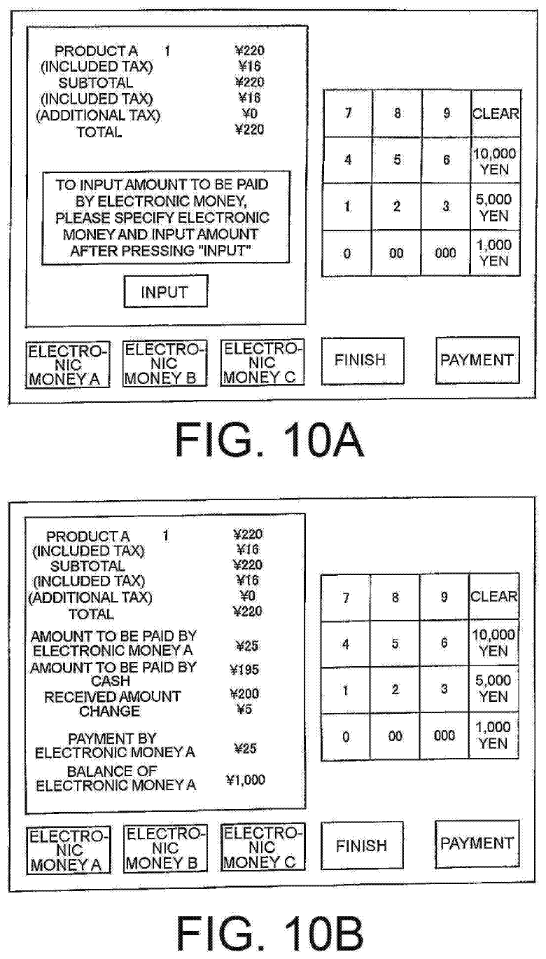

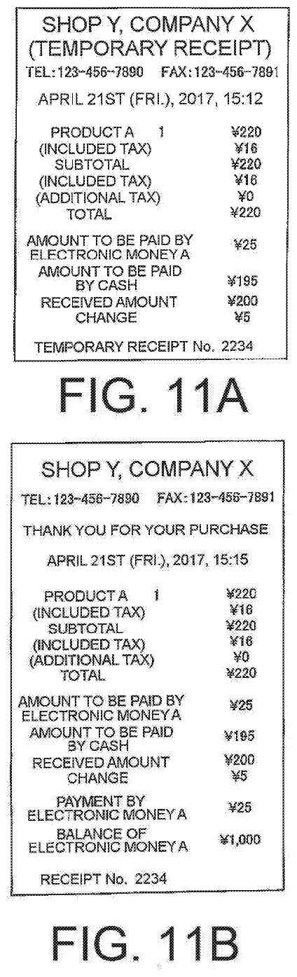

Next, a description is given of an operation of a POS terminal device according to a second embodiment of this invention with reference to FIG. 7 to FIG. 9, FIG. 10, and FIG. 11. The configuration of the POS system, the configuration of the shop server, and the configuration of the POS terminal device in the second embodiment are the same as those illustrated in FIG. 1 and FIG. 2.

The POS terminal device 120A (120B) in the second embodiment performs payment roughly in the following procedure.

(A) The POS terminal device calculates the total amount of a product to be purchased by a customer.

(B) It waits for specification of electronic money and reception of a desired amount to be paid, which is any amount desired by the customer for payment by electronic money, reception of input of a received amount, which is cash for payment, or specification of any one of the electronic money A, the electronic money B, and the electronic money C.

(C) The customer verbally notifies the clerk of specification of electronic money and an amount to be paid, which is any desired amount, or specifies electronic money on the customer operation screen (not shown) to input the amount to be paid, which is any desired amount.

(D) After that, the customer pays by cash an amount obtained by subtracting, from the total amount, the amount to be paid, which is any desired amount, by the specified electronic money.

(E) After that, the customer pays the outstanding balance (insufficient amount) by the specified electronic money.

FIG. 7 to FIG. 9 are flowcharts for illustrating processing to be executed by the control unit 121 of the POS terminal device 120A (120B) in the second embodiment from registration of a product to be purchased by the customer until payment of the product price.

FIG. 10 (a) is a clerk operation screen to be displayed on the clerk display unit 123a (FIG. 2 (b)) after calculation of the total amount of a product to be purchased, and FIG. 10 (b) is a clerk operation screen to be displayed on the clerk display unit 123a (FIG. 2 (b)) after completion of payment. FIG. 11 (a) is a temporary receipt to be issued by the printing unit 126 (FIG. 2 (b)) in the middle of payment, and FIG. 11 (b) is a receipt to be issued by the printing unit 126 (FIG. 2 (b)) after completion of payment.

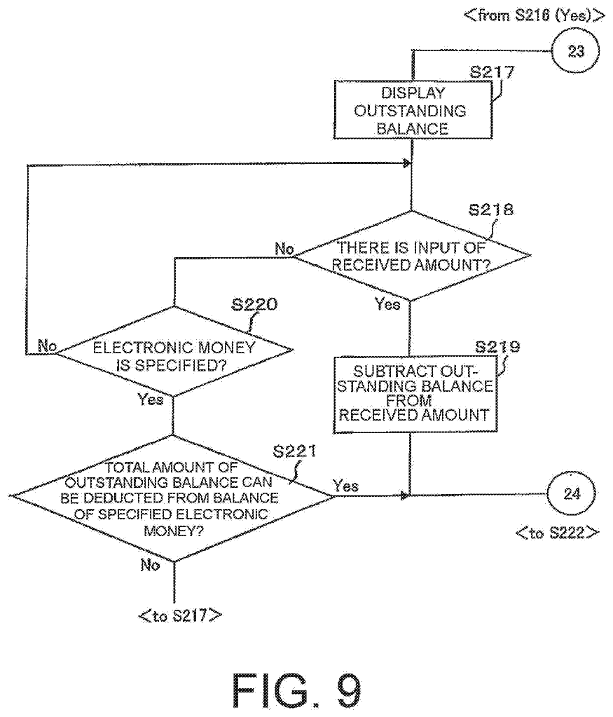

The second embodiment is different from the first embodiment in terms of flowchart in that Step S204 to Step S211 are inserted between Step S203 corresponding to Step S103 of the first embodiment and Step S212 corresponding to Step S104, and processing of the other steps is the same. In other words, the processing details of Step S201 to Step 203 and Step S212 to Step S222 of FIG. 7 and FIG. 9 are the same as those of Step S101 to Step 103 and Step S104 to Step S114 of FIG. 3 and FIG. 4 (first embodiment). Thus, only the difference from the flowchart of the first embodiment is described below.

In Step S203, after the total amount is calculated and displayed on the clerk display unit 123a and the customer display unit 123b (FIG. 2 (b)), in Step S204, it is determined whether there are specification of electronic money and input of any amount desired by the customer for payment by electronic money, that is, whether there is input of the amount to be paid, which is the desired amount for payment. When there are specification of electronic money and input of the desired amount to be paid, which is any amount desired by the customer for payment by electronic money, that is, when there is input of the amount to be paid (“Yes” in Step S204), the processing proceeds to Step S205. Otherwise (“No” in Step S204), the processing proceeds to Step S212.

As illustrated in FIG. 10 (a), the clerk display unit 123a (FIG. 2 (b)) displays the clerk operation screen to be used when the clerk specifies electronic money and inputs the amount to be paid. The customer display unit 123b (FIG. 2 (b)) also displays a similar customer operation screen (not shown).

In Step S205, the amount to be paid by cash is calculated by subtracting, from the total amount, the amount to be paid by electronic money, and the processing proceeds to Step S206.

In Step S206, the amount to be paid by cash is displayed on the clerk display unit 123a and the customer display unit 123b (FIG. 2 (b)), and the processing proceeds to Step S207.

In Step S207, it is determined whether the clerk has received cash for payment from the customer and the clerk has input a received amount. When the received amount is input (“Yes” in Step S207), the processing proceeds to Step S208. Otherwise (“No” in Step S207), Step S207 is repeated.

In Step S208, payment by cash is received. Specifically, the amount to be paid by cash is subtracted from the received amount, and the processing proceeds to Step S209.

In Step S209, it is determined whether there is a change. When there is a change (“Yes” in Step S209), the processing proceeds to Step S210. Otherwise (“No” in Step S209), the processing proceeds to Step S211.

In Step S210, the printing unit 126 (FIG. 2 (b)) issues a temporary receipt (FIG. 11 (a)), and the processing proceeds to Step S211. At this time, the clerk gives the change to the customer together with the temporary receipt.

In Step S211, payment by the specified electronic money is received. Specifically, the amount to be paid is deducted from the balance of the specified electronic money, and the processing proceeds to Step S216.

Step S210 may be deleted (the temporary receipt is not issued and the change is not given to the customer at this stage), and in Step S222, the receipt (final receipt) may be issued and the change may be given to the customer.

Further, Step S209 may be deleted, and the temporary receipt (FIG. 11 (a)) may be issued by the printing unit 126 (FIG. 2 (b)) irrespective of whether there is a change.

A specific example is given in the following.

The total amount of a product to be purchased is 220 yen. Meanwhile, the customer desires to pay 25 yen, which is any desired amount, by electronic money, which is the electronic money A with the balance of 1,025 yen. The customer verbally notifies the clerk of specification of the electronic money A and the amount to be paid of 25 yen, which is the desired amount for payment, or specifies the electronic money A on the customer operation screen (not shown) displayed on the customer display unit 123a (FIG. 2 (b)) to input the amount to be paid of 25 yen, which is the desired amount for payment. After that, the customer gives 200 yen to the clerk so as to cover 195 yen to be paid by cash, and receives the change of 5 yen and the temporary receipt (FIG. 11 (a)). Next, the customer pays 25 yen, which is the amount to be paid by the electronic money A. At this time, the clerk display unit 123a (FIG. 2 (b)) displays the clerk operation screen illustrated in FIG. 10 (b), and the printing unit 126 (FIG. 2 (b)) issues the receipt illustrated in FIG. 11 (b).

The POS terminal device according to the second embodiment described above can also set the amount of payment by electronic money to any amount desired by the customer.

### Third Embodiment

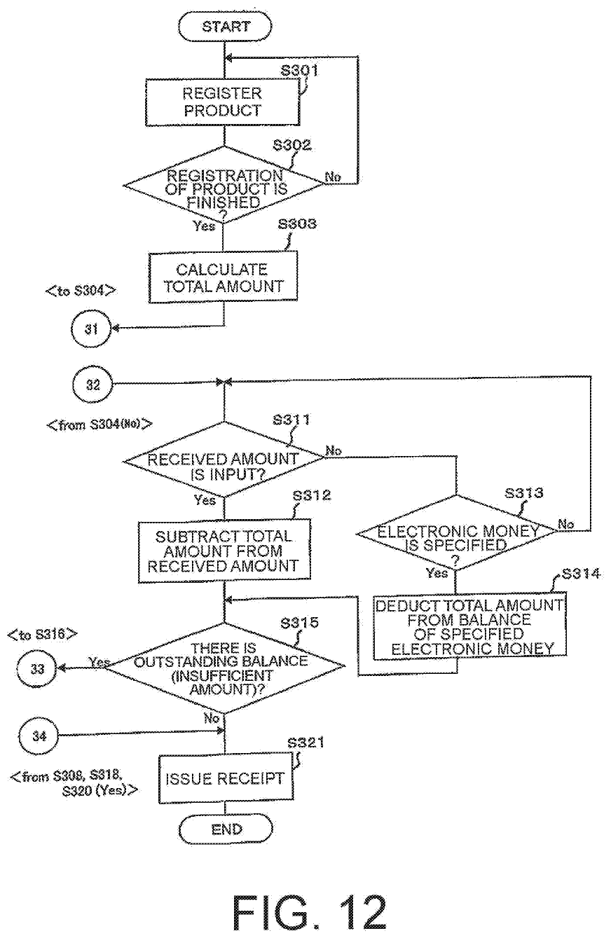

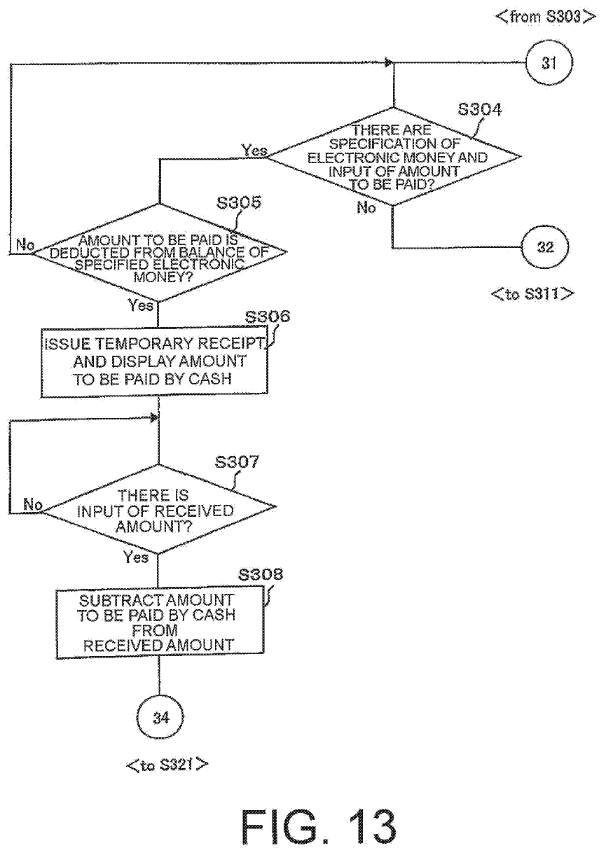

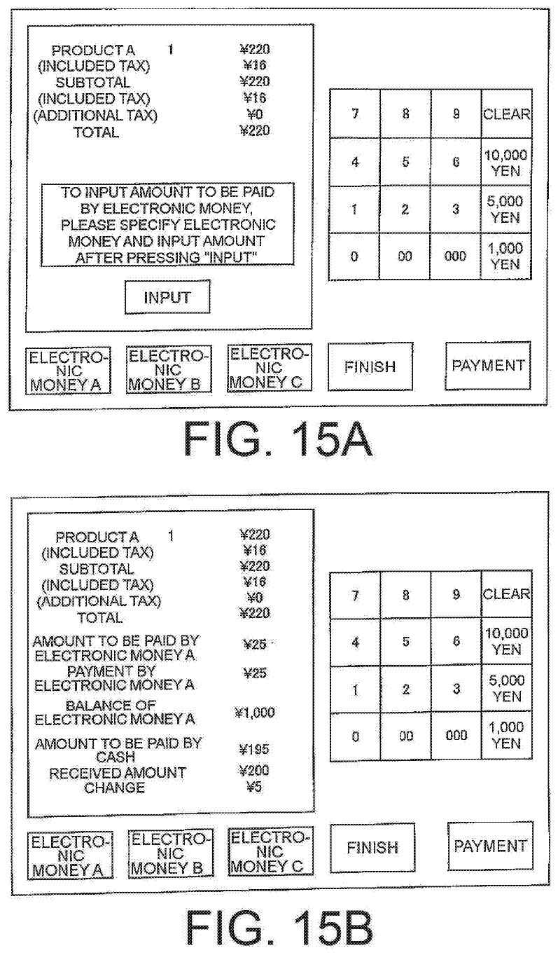

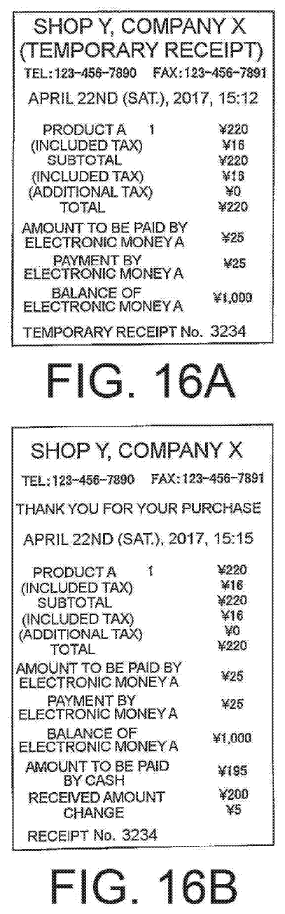

Next, a description is given of an operation of a POS terminal device according to a third embodiment of this invention with reference to FIG. 12 to FIG. 14, FIG. 15, and FIG. 16. The configuration of the POS system, the configuration of the shop server, and the configuration of the POS terminal device in the third embodiment are the same as those illustrated in FIG. 1 and FIG. 2.

The POS terminal device 120A (120B) in the third embodiment performs payment roughly in the following procedure.

(A) The POS terminal device calculates the total amount of a product to be purchased by a customer.

(B) It waits for specification of electronic money and reception of a desired amount to be paid, which is any amount desired by the customer for payment by electronic money, reception of input of a received amount, which is an amount of cash for payment, or specification of any one of the electronic money A, the electronic money B, and the electronic money C.

(C) The customer verbally notifies the clerk of specification of electronic money and an amount to be paid, which is any desired amount, or specifies electronic money on the customer operation screen (not shown) to input the amount to be paid, which is any desired amount.

(D) After that, the customer pays the amount to be paid, which is any desired amount, by the specified electronic money within the total amount.

(E) After that, the customer pays the outstanding balance (insufficient amount) by cash or other electronic money.

FIG. 12 to FIG. 14 are flowcharts for illustrating processing to be executed by the control unit 121 of the POS terminal device 120A (120B) in the third embodiment from registration of a product to be purchased by the customer until payment of the product price.

FIG. 15 (a) is a clerk operation screen to be displayed on the clerk display unit 123a (FIG. 2 (b)) after calculation of the total amount of a product to be purchased, and FIG. 15 (b) is a clerk operation screen to be displayed on the clerk display unit 123a (FIG. 2 (b)) after completion of payment. FIG. 16 (a) is a temporary receipt to be issued by the printing unit 126 (FIG. 2 (b)) in the middle of payment, and FIG. 16 (b) is a receipt to be issued by the printing unit 126 (FIG. 2 (b)) after completion of payment.

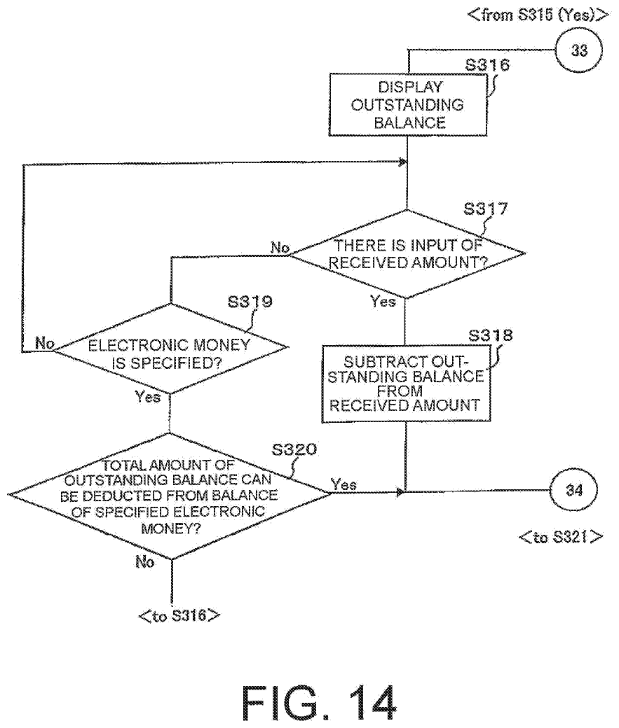

The third embodiment is different from the first embodiment in terms of flowchart in that Step S304 to Step S308 are inserted between Step S303 corresponding to Step S103 of the first embodiment and Step S311 corresponding to Step S104, and processing of the other steps is the same. In other words, the processing details of Step S301 to Step 303 and Step S311 to Step S321 of FIG. 12 and FIG. 14 are the same as those of Step S101 to Step 103 and Step S104 to Step S114 of FIG. 3 and FIG. 4 (first embodiment). Thus, only the difference from the flowchart of the first embodiment is described below.

In Step S303, after the total amount is calculated and displayed on the clerk display unit 123a and the customer display unit 123b (FIG. 2 (b)), in Step S304, it is determined whether there are specification of electronic money and input of any amount desired by the customer for payment by electronic money, that is, whether there is input of the amount to be paid, which is the desired amount for payment. When there are specification of electronic money and input of any amount desired by the customer to be paid by electronic money, that is, when there is input of an amount to be paid, which is an amount desired for payment, (“Yes” in Step S304), the processing proceeds to Step S305. Otherwise (“No” in Step S304), the processing proceeds to Step S311.

As illustrated in FIG. 15 (a), the clerk display unit 123a (FIG. 2 (b)) displays the clerk operation screen to be used when the clerk specifies electronic money and inputs the amount to be paid. The customer display unit 123b (FIG. 2 (b)) also displays a similar clerk operation screen (not shown).

In Step S305, it is determined whether the amount to be paid can be deducted from the balance of the specified electronic money. When the amount to be paid can be deducted from the balance of the specified electronic money (“Yes” in Step S305), the processing proceeds to Step S306. On the contrary, when the amount to be paid cannot be deducted due to, for example, the insufficiency of the balance, (“No” in Step S305), the fact that the amount to be paid cannot be deducted from the balance of the specified electronic money is displayed on the clerk display unit 123a and the customer display unit 123b (FIG. 2 (b)), and the processing returns to Step S304.

In Step S306, the printing unit 126 (FIG. 2 (b)) issues a temporary receipt (FIG. 16 (a)), and displays the amount to be paid by cash on the clerk display unit 123a and the customer display unit 123b (FIG. 2 (b)). Then, the processing proceeds to Step S307.

In Step S307, it is determined whether the clerk has received cash for payment from the customer and the clerk has input a received amount. When the received amount is input (“Yes” in Step S307), the processing proceeds to Step S308. Otherwise (“No” in Step S307), Step S307 is repeated.

In Step S308, payment by cash is received. Specifically, the amount to be paid by cash is subtracted from the received amount, and the processing proceeds to Step S321.

In Step S306, a temporary receipt may not be issued, and only the amount to be paid by cash may be displayed.

A specific example is given in the following.

The total amount of a product to be purchased is 220 yen. Meanwhile, the customer desires to pay 25 yen, which is any desired amount, by electronic money, which is the electronic money A with the balance of 1,025 yen. The customer verbally notifies the clerk of specification of the electronic money A and the amount to be paid of 25 yen, which is the desired amount for payment, or specifies the electronic money A on the customer operation screen (not shown) displayed on the customer display unit 123a (FIG. 2 (b)) to input the amount to be paid of 25 yen, which is the desired amount for payment. After that, the customer pays the amount to be paid of 25 yen by the electronic money A, and receives the temporary receipt (FIG. 16 (a)). Next, the customer gives 200 yen to the clerk so as to cover 195 yen to be paid by cash, and receives a change of 5 yen and a receipt (FIG. 16 (b)). At this time, the clerk display unit 123a (FIG. 2 (b)) displays the clerk operation screen illustrated in FIG. 15 (b), and the printing unit 126 (FIG. 2(b)) issues the receipt illustrated in FIG. 16 (b).

The POS terminal device according to the third embodiment described above can also set the amount of payment by electronic money to any amount desired by the customer.

### Fourth Embodiment

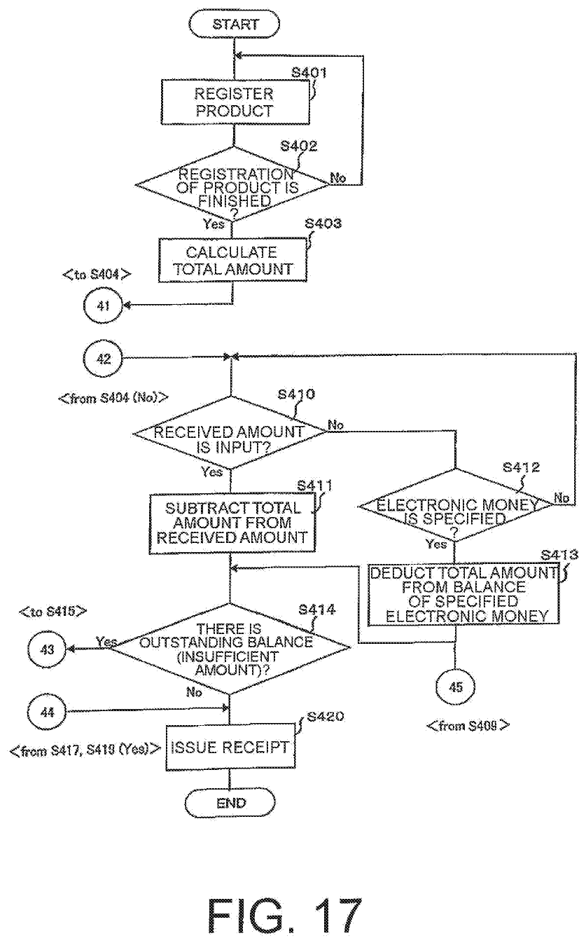

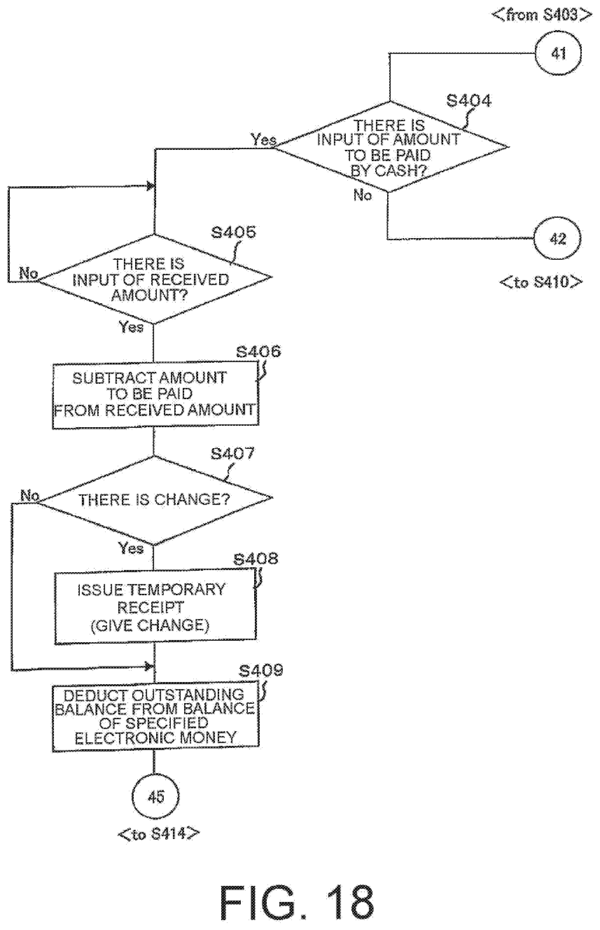

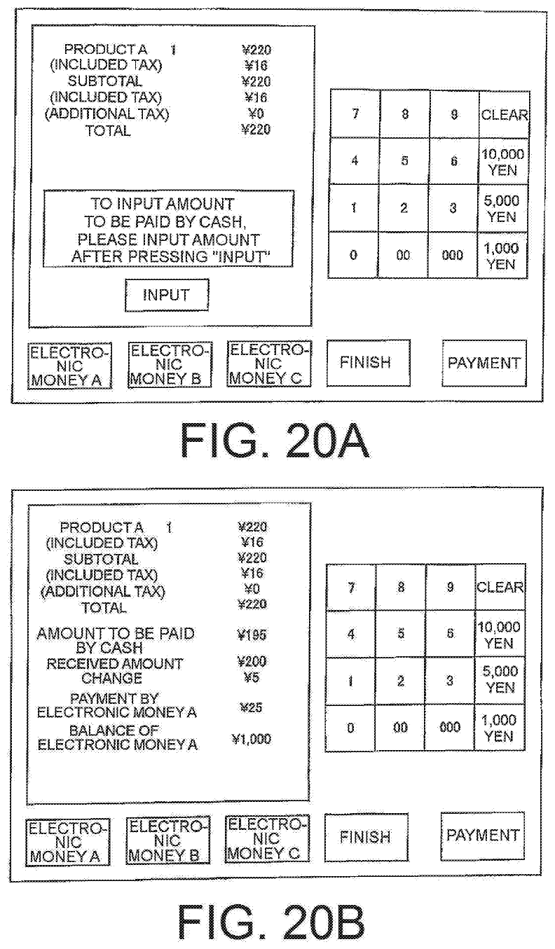

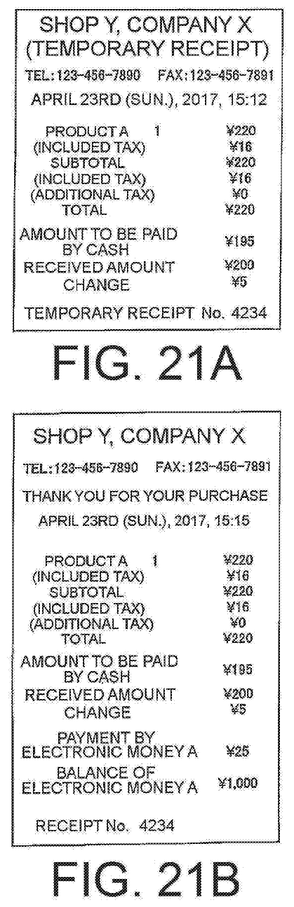

Next, a description is given of an operation of a POS terminal device according to a fourth embodiment of this invention with reference to FIG. 17 to FIG. 19, FIG. 20, and FIG. 21. The configuration of the POS system, the configuration of the shop server, and the configuration of the POS terminal device in the fourth embodiment are the same as those illustrated in FIG. 1 and FIG. 2.

The POS terminal device 120A (120B) in the fourth embodiment performs payment roughly in the following procedure.

(A) The POS terminal device calculates the total amount of a product to be purchased by a customer.

(B) It waits for reception of an amount desired by the customer for payment by cash, reception of input of a received amount, which is cash for payment, or specification of any one of the electronic money A, the electronic money B, and the electronic money C.

(C) The customer verbally notifies the clerk of a desired amount to be paid by cash, or inputs the desired amount to be paid by cash on the customer operation screen (not shown),

(D) After that, the customer pays the desired amount to be paid by cash within the total amount.

(E) After that, the customer specifies electronic money for payment of the outstanding balance (insufficient amount).

In the fourth embodiment, contrary to the second embodiment or the third embodiment, a desired amount to be paid by cash is input to determine the amount to be paid by electronic money. The amount to be paid by electronic money is any amount desired by the customer for payment by any one of the electronic moneys.

FIG. 17 to FIG. 19 are flowcharts for illustrating processing to be executed by the control unit 121 of the POS terminal device 120A (120B) in the fourth embodiment from registration of a product to be purchased by the customer until payment of the product price.

FIG. 20 (a) is a clerk operation screen to be displayed on the clerk display unit 123a (FIG. 2 (b)) after calculation of the total amount of a product to be purchased, and FIG. 20 (b) is a clerk operation screen to be displayed on the clerk display unit 123a (FIG. 2 (b)) after completion of payment. FIG. 21 (a) is a temporary receipt to be issued by the printing unit 126 (FIG. 2 (b)) in the middle of payment, and FIG. 21 (b) is a receipt to be issued by the printing unit 126 (FIG. 2 (b)) after completion of payment.

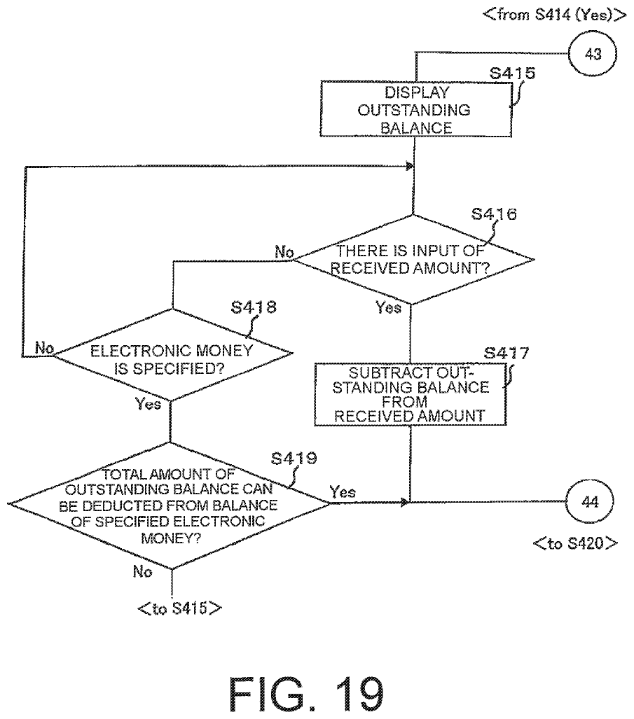

The fourth embodiment is different from the first embodiment in terms of flowchart in that Step S404 to Step S409 are inserted between Step S403 corresponding to Step S103 of the first embodiment and Step S410 corresponding to Step S104, and processing of the other steps is the same. In other words, the processing details of Step S401 to Step 403 and Step S410 to Step S420 of FIG. 17 and FIG. 19 are the same as those of Step S101 to Step 103 and Step S104 to Step S114 of FIG. 3 and FIG. 4 (first embodiment). Thus, only the difference from the flowchart of the first embodiment is described below.

After the total amount is calculated and displayed on the clerk display unit 123a and the customer display unit 123b (FIG. 2 (b)) in Step S403, in Step S404, it is determined whether there is input of the amount to be paid, which is an amount desired by the customer for payment by cash. When there is input of the amount to be paid, which is an amount desired by the customer for payment by cash (“Yes” in Step S404), the processing proceeds to Step S405. Otherwise (“No” in Step S404), the processing proceeds to Step S410.

As illustrated in FIG. 20 (a), the clerk display unit 123a (FIG. 2 (b)) displays the clerk operation screen to be used when the clerk inputs the amount to be paid by cash. The customer display unit 123b (FIG. 2 (b)) also displays a similar customer operation screen (not shown).

In Step S405, it is determined whether the clerk has received cash for payment from the customer and the clerk has input a received amount. When the received amount is input (“Yes” in Step S405), the processing proceeds to Step S406. Otherwise (“No” in Step S405), Step S405 is repeated.

In Step S406, payment by cash is received. Specifically, the amount to be paid is subtracted from the received amount, and the processing proceeds to Step S407.

In Step S407, it is determined whether there is a change. When there is a change (“Yes” in Step S407), the processing proceeds to Step S408. Otherwise (“No” in Step S407), the processing proceeds to Step S409.

In Step S408, the printing unit 126 (FIG. 2 (b)) issues a temporary receipt (FIG. 21 (a)), and the processing proceeds to Step S409. At this time, the clerk gives the change to the customer together with the temporary receipt.

In Step S409, payment by the specified electronic money is received. Specifically, the outstanding balance (insufficient amount) is deducted from the balance of the specified electronic money, and the processing proceeds to Step S414.

Step S408 may be deleted (the temporary receipt is not issued and the change is not given to the customer at this stage), and in Step S420, the receipt (final receipt) may be issued and the change may be given to the customer.

Further, Step S407 may be deleted, and the temporary receipt (FIG. 21 (a)) may be issued by the printing unit 126 (FIG. 2 (b)) irrespective of whether there is a change.

A specific example is given in the following.

The total amount of a product to be purchased is 220 yen. Meanwhile, the customer desires to pay 25 yen, which is any desired amount, by electronic money A with the balance of 1,025 yen. The customer verbally notifies the clerk of the amount to be paid of 195 yen, which is the desired amount for payment by cash, or inputs the amount to be paid of 195 yen, which is the desired amount for payment, on the customer operation screen (not shown) displayed on the customer display unit 123a (FIG. 2 (b)). After that, the customer gives 200 yen to the clerk so as to cover 195 yen to be paid by cash, and receives a change of 5 yen and a temporary receipt (FIG. 21 (a)). Next, the customer pays the outstanding balance of 25 yen by the electronic money A, and receives a receipt (FIG. 21 (b)). At this time, the clerk display unit 123a (FIG. 2 (b)) displays the clerk operation screen illustrated in FIG. 20 (b), and the printing unit 126 (FIG. 2 (b)) issues the receipt illustrated in FIG. 21 (b).

The POS terminal device according to the fourth embodiment described above can also set the amount of payment by electronic money to any amount desired by the customer.

In the flows of processing to be performed by the POS terminal device according to the first to fourth embodiments, after calculation of the total amount of a product to be purchased by the customer, or before or after any step until calculation of the total amount, the balance of electronic money of an electronic money medium desired by the customer may be read and displayed on the customer display unit 123b (FIG. 2 (b)).

Further, there are three types of electronic money as the electronic money usable in the POS terminal device according to the first to fourth embodiments. However, there may be one type of electronic money, or two, or four or more types of electronic money as the usable electronic money.

This application is based upon and claims the benefit of priority from Japanese patent application No. 2017-095939, filed on May 12, 2017, the disclosure of which is incorporated herein in its entirety by reference.

### Reference Signs List

100 POS system

110 shop server

111 control unit

111a storage unit

112 input unit

113 display unit

114 communication unit

120A, 120B POS terminal device

121 control unit

121a storage unit

122 input unit

123a clerk display unit

123b customer display unit

124 communication unit

125 reader/writer unit

126 printing unit

200A electronic money A management server

200B electronic money B management server

200C electronic money C management server

600 network

What is claimed is:

1-10. (canceled)

11. A POS terminal device, which is configured to receive payment by cash and payment by electronic money, the POS terminal device comprising a control unit configured to settle a payment, for a product price of a product to be purchased by a customer, by any of the cash, the electronic money, and the cash and the electronic money, a clerk display unit, and a customer display unit,
wherein the control unit is configured to receive, before reception of the payment by the electronic money, an input of a scheduled electronic money payment amount which is to be paid by the electronic money by the customer and which is smaller than the product price;
subtract the scheduled electronic money payment amount from the product price to calculate an amount corresponding to the payment by the cash, and displaying the amount corresponding to the payment by the cash;
receive, for the amount corresponding to the payment by the cash, the payment by the cash, and subtracting from the product price the amount corresponding to the payment by the cash to calculate an insufficient amount; and
receive, for the insufficient amount, the payment by the specified electronic money to settle the payment of the product price.

12. The POS terminal device according to claim 11, further comprising a printing unit configured to perform printing on a receipt sheet in accordance with an issue command received from the control unit,
wherein the control unit is configured to make the printing unit issue, after reception of the payment by the cash and, in case where there is a change, before reception of the payment by the electronic money, a temporary receipt in which at least the amount corresponding to the payment by the cash and an amount of the change are written.

13. A POS terminal device, which is configured to receive payment by electronic money in addition to payment by cash,
wherein the POS terminal device comprises a control unit configured to settle a payment, for a product price of a product to be purchased by a customer, by any of the cash, the electronic money, and the cash and the electronic money, a clerk display unit, and a customer display unit,
wherein the control unit is configured to:
receive, before reception of payment by electronic money, an input of a scheduled electronic money payment amount which is to be paid by the electronic money by the customer and which is smaller than the product price;
receive the payment by the electronic money , deduct the scheduled electronic money payment amount from a balance of the electronic money, subtract the scheduled electronic money payment amount from the product price to calculate an amount corresponding to the payment by the cash, and display the amount corresponding to the payment by the cash; and
receive, for the amount corresponding to the payment by the cash, the payment by the cash to settle the payment for the product price ,
the POS terminal device further comprising a printing unit configured to perform printing on a receipt sheet in accordance with an issue command received from the control unit,
wherein the control unit is configured to make the printing unit issue, after reception of the payment by the electronic money and before reception of the payment by the cash, a temporary receipt in which at least the amount corresponding to the payment by the cash is written.

14. The POS terminal device,
which is configured to receive payment by electronic money in addition to payment by cash,
wherein the POS terminal device comprises a control unit configured to settle a payment, for a product price of a product to be purchased by a customer, by any of the cash, the electronic money, and the cash and the electronic money,
wherein the control unit is configured to:
receive, before reception of the payment by the cash, an input of a scheduled cash payment amount which is an amount to be paid by the cash by the customer and which is smaller than the product price;
receive, for the scheduled cash payment amount, the payment by the cash and subtract the scheduled cash payment amount from the product price to calculate an insufficient amount; and
receive the payment by the electronic money for the insufficient amount to thereby settle the payment of the product price,
the POS terminal device further comprising a printing unit configured to perform printing on a receipt sheet in accordance with an issue command received from the control unit,
wherein the control unit is configured to make the printing unit issue, after reception of the payment by the cash and, in case where there is a change, before reception of the payment by the electronic money, a temporary receipt in which at least the scheduled cash payment amount and an amount of the change are written.

15. The POS terminal device according to claim 14, further comprising a clerk display unit to display a clerk operation screen and a customer display unit to display a customer operation screen.

16. The POS terminal device according to claim 11, wherein the POS terminal device is configured to receive payment by a plurality of types of electronic money and to receive specification of any of the plurality of types of electronic money.

17. The POS terminal device according to claim 12, wherein the POS terminal device is configured to receive payment by a plurality of types of electronic money and to receive specification of any of the plurality of types of electronic money.

18. The POS terminal device according to claim 13, wherein the POS terminal device is configured to receive payment by a plurality of types of electronic money and to receive specification of any of the plurality of types of electronic money.

19. The POS terminal device according to claim 14, wherein the POS terminal device is configured to receive payment by a plurality of types of electronic money and to receive specification of any of the plurality of types of electronic money.

20. The POS terminal device according to claim 15, wherein the POS terminal device is configured to receive payment by a plurality of types of electronic money and to receive specification of any of the plurality of types of electronic money.

21. A POS system, comprising the POS terminal device of claim 11 and a shop server,
wherein the shop server includes a storage unit storing a PLU file that associates a product code with information on a product, and is configured to return, in response to transmission of a product code from the POS terminal device, information on a product corresponding to the product code,
wherein the POS terminal device is configured to calculate the product price based on the information on the product returned by the shop server.

22. A POS system, comprising the POS terminal device of claim 12 and a shop server,
wherein the shop server includes a storage unit storing a PLU file that associates a product code with information on a product, and is configured to return, in response to transmission of a product code from the POS terminal device, information on a product corresponding to the product code,
wherein the POS terminal device is configured to calculate the product price based on the information on the product returned by the shop server.

23. A POS system, comprising the POS terminal device of claim 13 and a shop server,
wherein the shop server includes a storage unit storing a PLU file that associates a product code with information on a product, and is configured to return, in response to transmission of a product code from the POS terminal device, information on a product corresponding to the product code,
wherein the POS terminal device is configured to calculate the product price based on the information on the product returned by the shop server.

24. A POS system, comprising the POS terminal device of claim 14 and a shop server,
wherein the shop server includes a storage unit storing a PLU file that associates a product code with information on a product, and is configured to return, in response to transmission of a product code from the POS terminal device, information on a product corresponding to the product code,
wherein the POS terminal device is configured to calculate the product price based on the information on the product returned by the shop server.

25. A POS system, comprising the POS terminal device of claim 15 and a shop server,
wherein the shop server includes a storage unit storing a PLU file that associates a product code with information on a product, and is configured to return, in response to transmission of a product code from the POS terminal device, information on a product corresponding to the product code,
wherein the POS terminal device is configured to calculate the product price based on the information on the product returned by the shop server.

26. A POS system, comprising the POS terminal device of claim 16 and a shop server,
wherein the shop server includes a storage unit storing a PLU file that associates a product code with information on a product, and is configured to return, in response to transmission of a product code from the POS terminal device, information on a product corresponding to the product code,
wherein the POS terminal device is configured to calculate the product price based on the information on the product returned by the shop server.

27. A POS system, comprising the POS terminal device of claim 17 and a shop server,
wherein the shop server includes a storage unit storing a PLU file that associates a product code with information on a product, and is configured to return, in response to transmission of a product code from the POS terminal device, information on a product corresponding to the product code,
wherein the POS terminal device is configured to calculate the product price based on the information on the product returned by the shop server.

28. A POS system, comprising the POS terminal device of claim 18 and a shop server,
wherein the shop server includes a storage unit storing a PLU file that associates a product code with information on a product, and is configured to return, in response to transmission of a product code from the POS terminal device, information on a product corresponding to the product code,
wherein the POS terminal device is configured to calculate the product price based on the information on the product returned by the shop server.

29. A POS system, comprising the POS terminal device of claim 19 and a shop server,
wherein the shop server includes a storage unit storing a PLU file that associates a product code with information on a product, and is configured to return, in response to transmission of a product code from the POS terminal device, information on a product corresponding to the product code,
wherein the POS terminal device is configured to calculate the product price based on the information on the product returned by the shop server.

30. A POS system, comprising the POS terminal device of claim 20 and a shop server,
wherein the shop server includes a storage unit storing a PLU file that associates a product code with information on a product, and is configured to return, in response to transmission of a product code from the POS terminal device, information on a product corresponding to the product code,
wherein the POS terminal device is configured to calculate the product price based on the information on the product returned by the shop server.
